(19) United States
(12) Patent Application Publication
(10) Pub. No.: US 2015/0142768 A1
(43) Pub. Date: May 21, 2015

(54) STORED DEVICE WITH SEARCHING ENGINES

(71) Applicant: Sage Microelectronics Corp., Saratoga, CA (US)

(72) Inventors: Jianjun Luo, Los Gatos, CA (US); Hailuan Liu, Hangzhou (CN)

(73) Assignee: Sage Microelectronics Corp., Saratoga, CA (US)

(21) Appl. No.: 14/083,380

(22) Filed: Nov. 18, 2013

(51) Int. Cl. G06F 17/30

(52) U.S. Cl. CPC G06F 17/30864
USPC 707/706

(57) ABSTRACT

A self-search storage device includes a data buffer coupled between a host and a data storage medium and configured to receive a configuration information including keywords from the host. The self-search storage device further includes a data compare engine coupled to the data buffer and the data storage medium and including more than one data search units. The data compare engine is configured to receive data from the data bus and operable to employ the more than one data search units to compare parts of the data to the keyword, each data search unit of the more than one data search units comparing a distinct part of the data to the keyword, the data compare engine further operable to report the outcome of the comparison for use by the host.

### BACKGROUND

Various embodiment of the invention relate generally to search engines and particularly to search engines employed for storage devices.

Digital information explosion continues to rapidly increase in the amount of published information or data available to users and the effects of this abundance of information. As the amount of data grows, the challenge to find useful information from network devices also grows. Though search engine technology has improved by many folds, search efficiency remains the bottle neck for search engines. Information is generally stored in many network devices, such as servers. Finding relevant information from thousands and thousands of storage/network devices is currently inefficient. One might wonder why these devices do not search the information internally with embedded searching engines and report the result to a system? In this way, even the searching results feedback from these devices are not accurate enough, it will help to improve the system searching efficiency.

The days of searching on a single server are long gone due to the limitation of computer speeds. Such kind of a solution is implemented by software instead of hardware searching engines. This has been replaced with distributed storage using multiple hardware engines which share search tasks and distribute among storage channels, with this approach being commonplace. However, it is very costly to maintain the many storage/network devices at an added cost of high power consumption.

Accordingly, there is a need for less costly and low power-consuming search engine storage devices.

### SUMMARY

Briefly, a self-search storage device includes a data buffer coupled between a host and a data storage medium and configured to multi-function receiving search configure information from the host and caching data from/to data storage medium and storing the search result information in the host. The self-search storage device further includes a data compare engine coupled to the data buffer and the data storage medium and including more than one data search units. The data compare engine is configured to receive a data stream from/to data storage medium and operable to employ the more than one data search units to compare the data to the keyword, each data search unit being configured with different keywords where more than one keyword is being searched concurrently, the data compare engine further operable to report the outcome of the comparison for use by the host.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a self-search storage device 2 coupled to a host 1, in accordance with an embodiment of the invention.

FIG. 2 shows further details of the self-search storage device 2, in accordance with an embodiment of the invention.

FIG. 3 shows an alternate configuration of the self-search storage device controller 21′, in accordance with another embodiment of the invention.

FIG. 4 shows further details of the data compare engine 212, in accordance with an embodiment of the invention.

FIG. 5 shows further details of one of the data search units of FIG. 4, in accordance with an embodiment of the invention.

FIG. 6 shows a flow chart 600 of the relevant steps performed by the self-search storage device 2, in accordance with a method of the invention.

FIG. 7 shows a flow chart 700 of the relevant steps performed by the self-search storage device 2, in accordance with a method of the invention.

FIG. 8 shows a flow chart 800 of the relevant steps performed by the self-search storage device 2, in accordance with a method of the invention.

### DETAILED DESCRIPTION OF EMBODIMENTS

Particular embodiments and methods of the invention disclose a self-search storage device includes a data buffer coupled between a host and a data storage medium and configured to multi-function by receiving a search configure information from the host and caching data from/to data storage medium and storing the search result information in the host. The self-search storage device further includes a data compare engine coupled to the data buffer and the data storage medium and including more than one data search units. The data compare engine is configured to receive a data stream from/to data storage medium and operable to employ the more than one data search units to compare the data to the keyword, each data search unit being configured with different keywords where more than one keyword is being search at the same time. The data compare engine further operable to report the outcome of the comparison for use by the host.

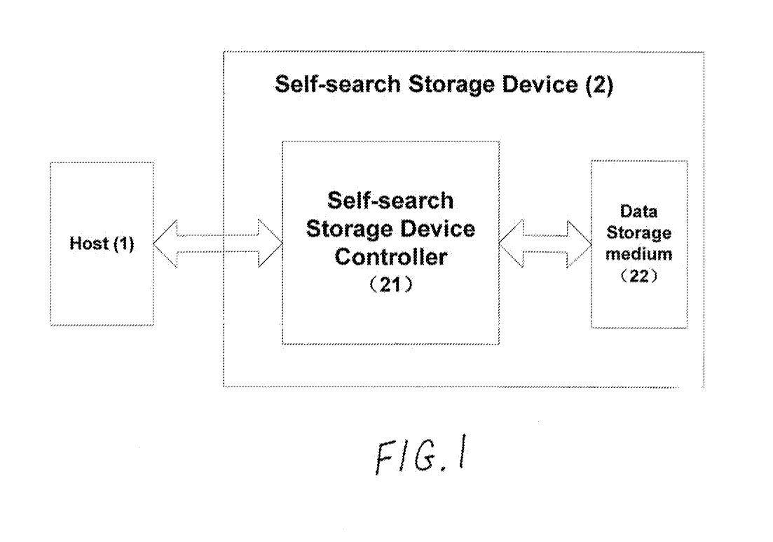

Referring now to FIG. 1, a self-search storage device 2 is shown coupled to a host 1, in accordance with an embodiment of the invention. The self-search storage device 2 is shown to include a self-search storage device controller 21 and a data storage medium 22 with the two being coupled together. The self-search storage device controller 21 is also shown coupled to the host 1.

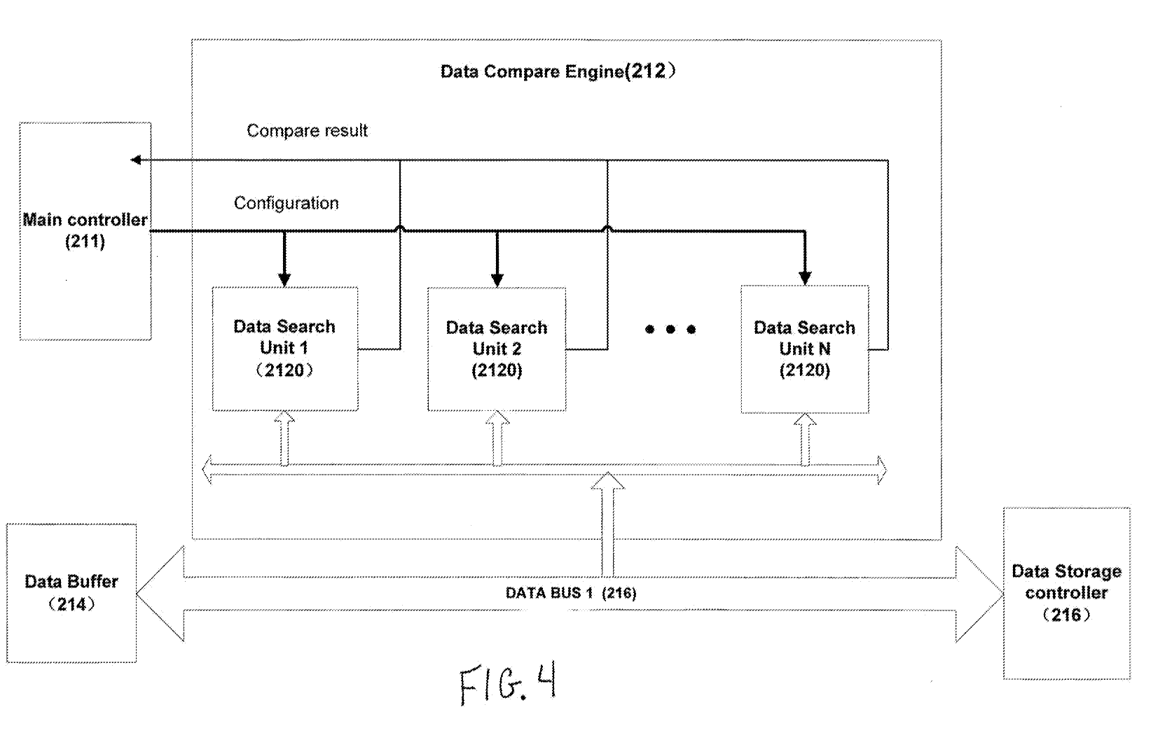

In operation, the host 1 issues a search command with a list of keywords to the controller 21 which distributes the keywords to multiple data search units (shown in FIG. 4). Each data search unit monitors one keyword of the data stream from/to the data storage medium. In this sense, the data and search are distributed allowing for substantially simultaneous and real-time and therefore efficient search of the data storage medium 22. The data storage medium 22 generally includes a substantially large number of storage devices that may be remotely coupled to each other and the self-search storage device controller 21.

The self-search storage device controller 21 includes a data compare engine that is capable of searching more than one keywords in a data stream. The self-search storage device 2 is further capable of monitoring the data stream from the host 1 to the data storage medium 22, monitoring the data stream from the data storage medium 22 to the host 1, automatically reading the data from data storage medium to data buffer and searching keywords in the meanwhile, or any kind of data streaming in/out of the self-search storage device controller 21.

The self-search storage device controller 21 is self-contained in terms of searching and in this respect, it is self-searching.

In some embodiments of the invention, the host 1 may be a desktop/notebook computer, a server system, a mobile computing device, or any other suitable device capable of accessing the storage medium 22. The self-search storage device controller 21 may be a hard disk, a Solid State Device (SSD), a Personal Computer Memory Card International Association (PCMCIA) card, a Secure Digital Memory Card (SD)/MultiMediaCard (MMC) card, a universal serial bus (USB) disk, a micro-SD card, a Embedded MultiMediaCard (EMMC) chip, a compact disk (CD), a Digital Video Disc (DVD), or any other device for non-violation data storage. The data storage medium 22 may be flash, magnetic storage medium, magnetic tape, or any non-volatile memory.

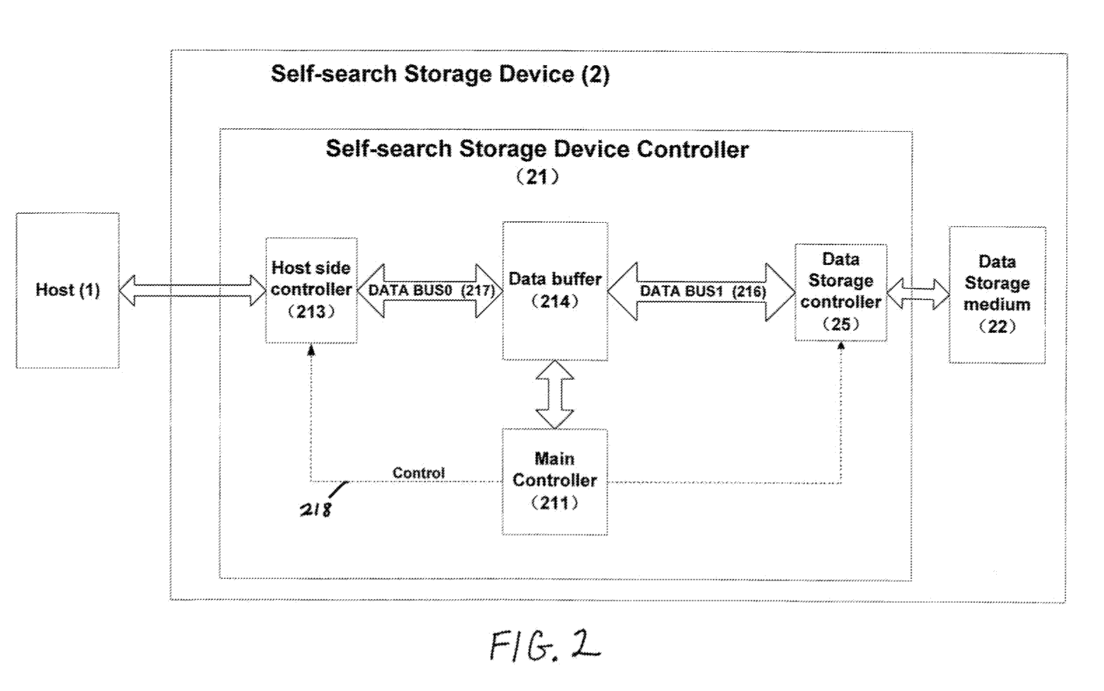

FIG. 2 shows further details of the self-search storage device 2, in accordance with an embodiment of the invention. The self-search storage device 2 is shown to include a self-search storage device controller 21 coupled to the host 1 and the data storage medium 22. The self-search storage device controller 21 is shown to include a host side controller 213, a data buffer 214, a data storage controller 215, a data compare engine 212, a main controller 211, a data bus0 217, and a data bus1 216. The main controller 211 is also shown coupled to the data storage controller 215.

The host side controller 213 is shown coupled to the host 1 and the data buffer 214, the latter coupling being through the data bus0 217. The data buffer 214 is further shown coupled to the main controller 211 and the data storage controller 215 with the latter coupling being through the data bus1 216. The data storage controller 215 is additionally shown coupled to the data storage medium 22. Through the data bus1 216, the data storage controller 215 and the data buffer 214 are shown coupled to the data compare engine 212. The data compare engine 212 is shown coupled to the main controller 211, which is shown coupled to the data buffer 214. The main controller 211 is shown to generate a control signal 218 to the host side controller 213.

The main controller 211 communicates command and data to the host 1 through the host side controller 213. Further, the main controller 211 accesses and manages the data storage medium 22 using the data storage controller 215 and/or configures keywords for the data compare engine 212.

The data compare engine 212 includes several data search units used to perform real-time keyword data searching with the result of the search being coupled onto the data bus1 216. The host side controller 213 handles the protocol between the host 1 and the data storage medium 22. Examples of such protocol are, without limitation, Serial Advanced Technology Attachment (SATA), Peripheral Component Interconnect (PCI), PCI Express (PCIE), Serial Attached SCSI (SAS), 1394, USB, SD, or MMC, or any suitable protocol for data exchange.

The data buffer 214 has a multi-function capability. For example, it caches data when the host writes data to the data storage medium or reads data from the data storage medium. It further temporarily stores search configure information data from the host or the search result information that is ultimately sent to the host and in this respect, may be employed by the main controller 211 as a data cache. The data storage controller 215 manages accesses to the data storage medium 22.

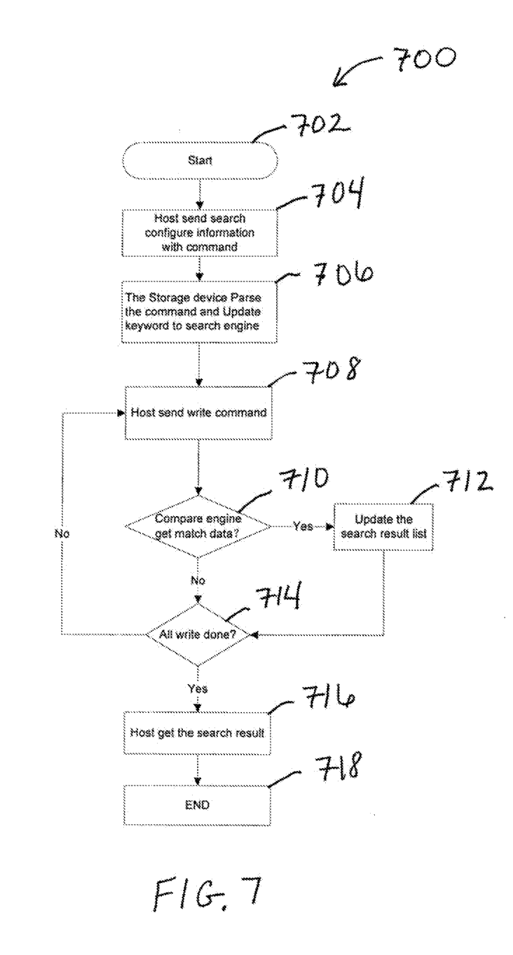

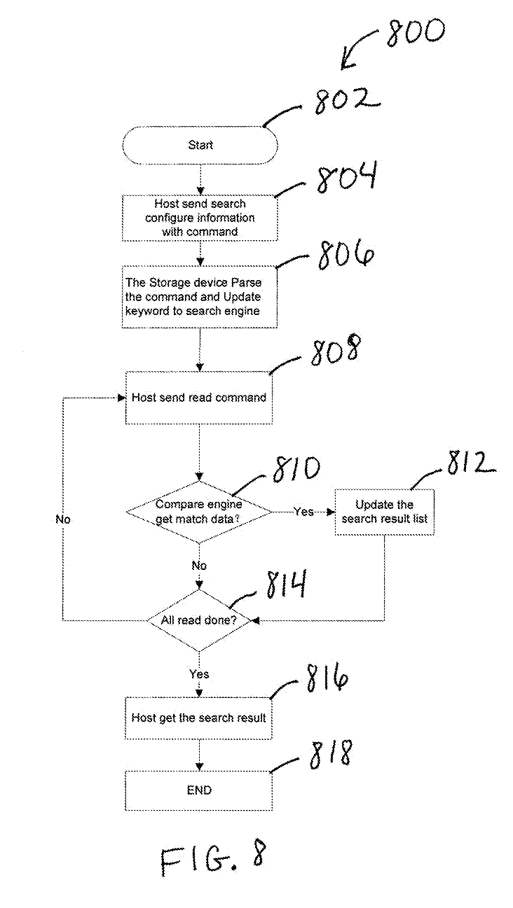

In operation, the host side controller 213 receives a command with a list of keywords and a search range (collectively referred to herein as “search information”) from the host 1 and communicates the same to the data buffer 214 through the data bus0 217. The main controller 211 fetches the search information from data the buffer 214 and communicates the keywords to the data compare engine 212 for comparison of the keywords with data that is in the data storage medium 22. The main controller 211 controls the data storage controller 215 to start to read according to the search range, communicated by host. The data storage controller 215 receives data from data storage medium 22 and communicates the same to data buffer 214 through the data bus1 216. The data that is in the data storage medium 22 is received by the data storage controller 215 and passed onto the data compare engine 212. The data compare engine 212 compares the data to a keyword and reports the result to main controller 211. The main controller 211 stores the result in the data buffer 214 and reports the result of the comparison back to the host when the search is done. Additional commands, such as write and read commands described in FIGS. 7 and 8, may be received by the host side controller 213 from the host 1.

The control signal 218 indicates that the main controller 211 can control the host side of the controller 213 to start a command or data transfer. An example of the main controller 211 is a central processing unit and available to control another module]

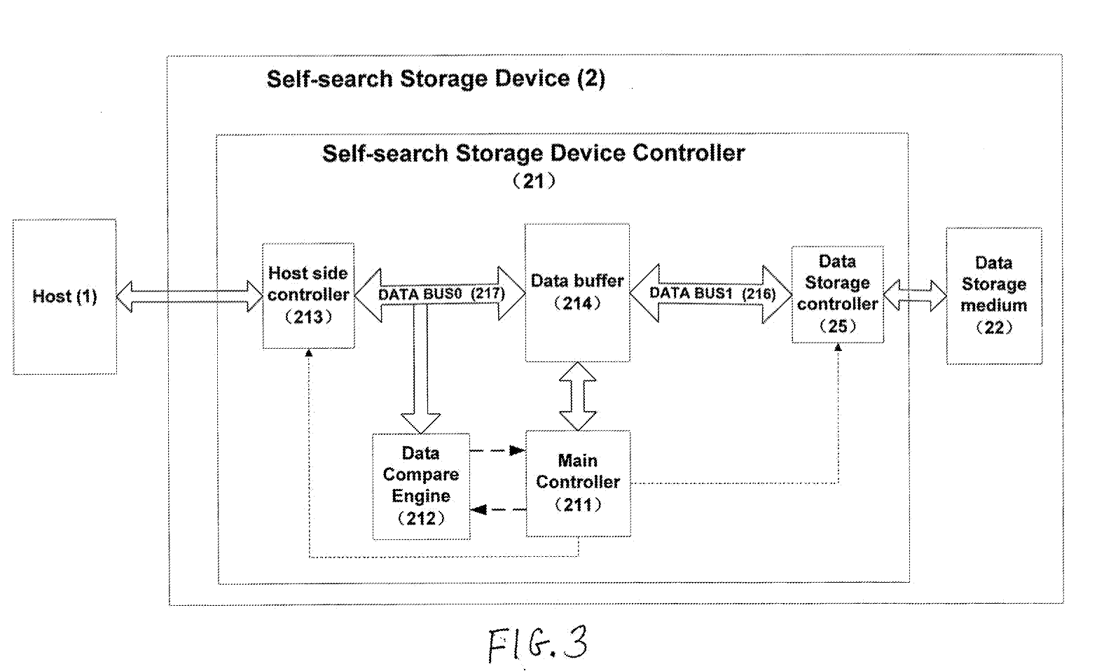

FIG. 3 shows an alternate configuration of the self-search storage device controller 21′, in accordance with another embodiment of the invention. In the embodiment of FIG. 3, the data compare engine 212 is shown coupled to the data bus0 217 and therefore coupled to the host side controller 213 and the data buffer 214. Save for this exception, the self-search storage device controller 21′ is analogous to the self-search storage device controller 21 of FIG. 2 In the case where the data compare engine 212 is coupled between the data buffer and the data storage controller, self-search is easier performed because data is read from the data storage 22 and transferred to the data buffer 214 just for keyword searching and the data can be discarded after searching.

FIG. 4 shows further details of the data compare engine 212, in accordance with an embodiment of the invention. The data compare engine 212 is shown to include data search units 1 2120 through N 2120, with “N” being an integer, which are shown coupled to the data bus1 216 or bus0 217. The main controller 211 provides configuration and keyword information to the data search units 1−N. These 1−N keywords in all 1−N search units are different values or patterns in general. Each of the data search units 1−N compares the data on bus1 216 or bus0 217 to its keyword configured by the main controller 211 and provides the result of the comparison to the main controller 211. The keyword among the data search units can be different. Accordingly, parallel and real-time comparisons of the keyword and the data is achieved. Each of the data search units 1−N includes a keyword latch, or any other suitable storage element, for storing the keyword to be searched.

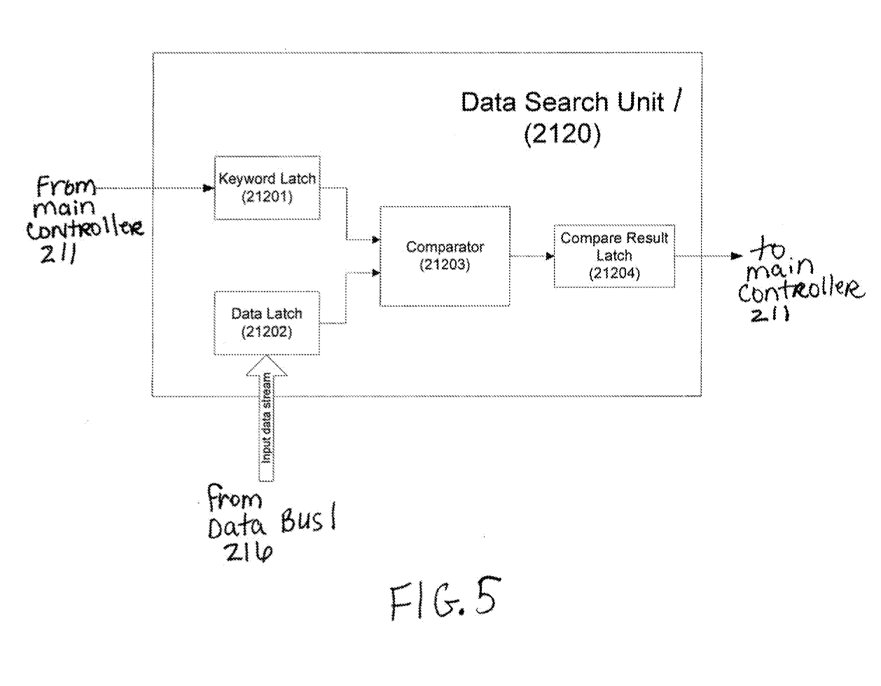

FIG. 5 shows further details of one of the data search units of FIG. 4, in accordance with an embodiment of the invention. The data search unit of FIG. 5 is the data search unit 1 2120 and is shown to include a keyword latch 21201, a data latch 21202, a comparator 21203, and a compare result latch 21204. The keyword latch 21201 is coupled to the main controller 211 and the comparator 21203. The data latch 21202 is coupled to the data bus1 and the comparator 21203. The comparator 21203 is coupled to the compare result latch 21204, which is coupled to the main controller 211. The data from the main controller 21, such as the keyword, is stored in the keyword latch 21201 and the data from the host 1, through the data bus1, is stored in the data latch 21202. The comparator 21203 compares the output of the keyword latch 21201 to the output of the data latch 21202 and generates the result of the comparison, which is stored in the compare result latch 21204. The output of the compare result latch 21204 is transmitted to the main controller 211.

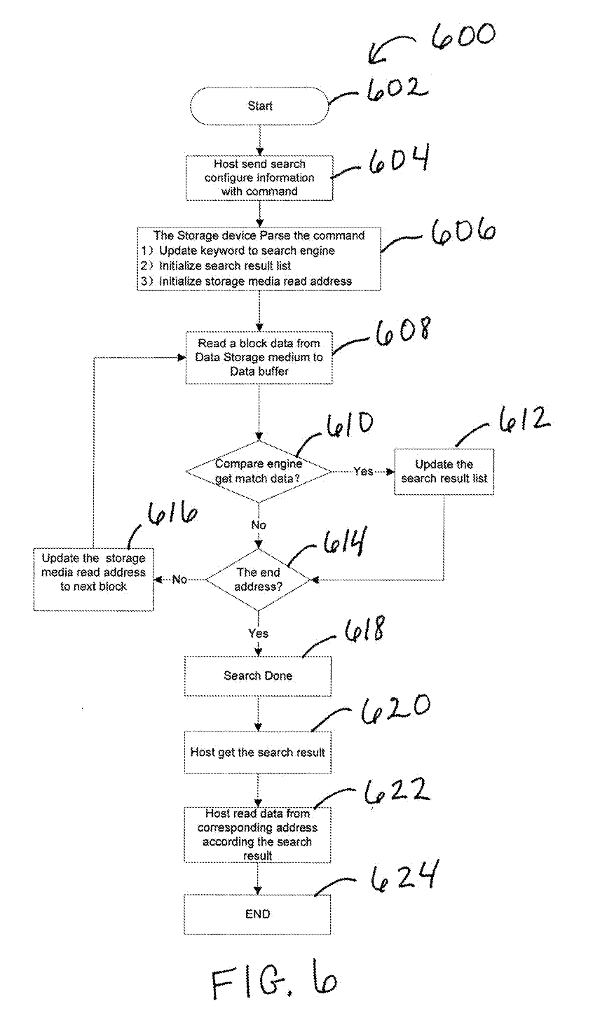

FIG. 6 shows a flow chart 600 of the relevant steps performed by the self-search storage device 2, in accordance with a method of the invention. At 602, the process begins. At step 604, the host 1 sends a command with search configuration information to the self-search storage device 2. The search configuration contains 1-N keywords and search range information. Next, at step 606, the storage device 2 parses the received command by updating the keyword to be searched, initializing a search result list, and initializing a read address associated with the data storage media 22. Next, at step 608, the device controller 21 reads a block of data from the data storage medium 22 and stores the read block of data in the data buffer 214. Subsequently, a determination is made, at 610, as to whether or not the data compare engine 212 has found a match and if so, the search result list is updated to include the newly-found match and the process continues to 614. The search result list is generally maintained in the data buffer 214. Parts of the data buffer 214 are used as to cache data between the host and the storage media and parts of the data are saved in the main controller's data memory. The search result is kept in the data memory. If no match is found at 610, the process continues to 614 to determine whether or not the last, or “end”, address of the block of data has been encountered. If so, the process continues to step 618 and if not, the process goes to step 616. At step 616, the read address of the storage medium 22 is updated to the next block and the process repeats for the next block starting from the step 608.

If at 614, it is determined that the entire block has been processed, at step 618, the search is considered done. Next, at step 620, the storage device 2 sends the host 1 the search result. Next, at step 622, the host 1 reads the data that the host 1 sent at step 604, from the corresponding address, through the controller 21, according to the search result. That is, at step 604, the keyword information is sent and at step 622, the host knows the address of the data that contains the keyword. Accordingly, the host need not read all of the data from the storage medium and move it to the computer memory and then search using the CPU. Instead, the host simply sends the keyword to the storage medium, which automatically searches for the keyword(s) and reports the result of the search by reporting the location of the data that includes the keyword. Thus, the time that is required to transfer the data to the host is saved and because search is performed by dedicated hardware and in real-time, the CPU search time is eliminated and the host CPU tasks are reduced. The process ends at 624.

FIG. 7 shows a flow chart 700 of the relevant steps performed by the self-search storage device 2, in accordance with a method of the invention. At 702, the process begins. At step 704, the host 1 sends a command with search configuration information to the self-search storage device 2. The search configuration contains 1−N keywords and search range information. Next, at step 706, the storage device 2 parses the received command by updating the keyword to be searched. Next, at step 708, the host 1 sends a write command to the device 2 and at 710, a determination is made by the data compute engine 212, as to whether or not there is a match between the keyword provided by the host 1 and the write data stream from host 1 to data storage medium 22. If a match is detected at 710, the process continues to step 712 and if no match is found, the process continues to 714 where it is determined whether or not the write operation has ended. At step 712, the search result list is updated and the process continues to 714.

If at 714, it is determined that the write operation is completed, the process continues to step 716 and if not, the process repeats starting from step 708 until the write operation is complete. At step 716, the host 1 receives the search result and at 718, the process ends. In summary, the process of FIG. 7 shows a writing process. The host configures keyword(s) before a write operation, then the storage medium monitors the write data stream from the host and records it if the write data stream contains the keyword, which aids in detecting viruses because keywords related to viruses can be stored and when a virus keyword is detected in the write data stream, the host can be warned.]

FIG. 8 shows a flow chart 800 of the relevant steps performed for reading by the self-search storage device 2, in accordance with a method of the invention. At 802, the process begins. At step 804, the host 1 sends a command with search configuration information to the self-search storage device 2. The search configuration contains 1−N keywords and search range information. Next, at step 806, the storage device 2 parses the received command by updating the keyword to be searched. Next, at step 808, the host 1 sends a read command to the device 2 and at 810, a determination is made by the data compute engine 212, as to whether or not there is a match between the keyword provided by the host 1 and the read data stream form the data storage medium 22. If a match is detected at 810, the process continues to step 812 and if no match is found, the process continues to 814 where it is determined whether or not the write operation has ended. At step 812, the search result list is updated and the process continues to 814.

If at 814, it is determined that the read operation is completed, the process continues to step 816 and if not, the process repeats starting from step 808 until the read operation is complete. At step 816, the host 1 is sent the search result and at 818, the process ends.

One of the differences between the process of FIG. 6 and that of FIG. 8 is in the latter, all of the data to host 1 needs to be read while in the former, only the data to the data buffer 214 needs to be read and can then be discarded.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A self-search storage device comprising:
a self-search storage device controller including,
a data buffer coupled between a host and a data storage medium and configured to multi-function that receive a search configure information from the host and cache data from/to data storage medium and store the search result information to host; and
a data compare engine coupled to the data buffer and the data storage medium and including more than one data search units, The data compare engine is configured to receive data stream from/to data storage medium and operable to employ the more than one data search units to compare the data to the keyword, each data search unit configured with a different keyword that is more than one keyword being searched, the data compare engine further operable to report the outcome of the comparison for use by the host.

2. The self-search storage device, as recited in claim 1, further including a host side controller coupled to the data buffer and the host, the host side controller configured to send the configuration information, including search commands and keywords, and to provide search results to the host.

3. The self-search storage device, as recited in claim 1, further including a data storage controller coupled to the data buffer and the data storage medium and responsive to the data.

4. The self-search storage device, as recited in claim 1, wherein the data search unit of at least one data search unit includes a keyword latch, a data latch, a comparator, and a compare result latch, the keyword latch and the data latch being coupled to the comparator and the comparator being coupled to the compare result latch, the keyword latch configured to store the keyword and the data latch configured to store the data, the comparator operable to compare the stored keyword and the stored data and to provide the result of the comparison to the compare result latch.

5. The self-search storage device, as recited in claim 1, wherein the self-search storage device controller is a hard disk, a Solid State Device (SSD), a Personal Computer Memory Card International Association (PCMCIA) card, a Secure Ditital Memory Card (SD)/MultiMediaCard (MMC) card, a universal serial bus (USB) disk, a micro-SD card, a Embedded MultiMediaCard (EMMC) chip, a compact disk (CD), or a Digital Video Disc (DVD).

6. The self-search storage device, as recited in claim 1, wherein the data storage medium is flash, magnetic storage medium, or magnetic tape.

7. A method of searching in a self-search storage device comprising:
receiving a search command with search configuration information;
parsing the search command and initializing a search result list;
reading a block of data from a data storage medium to the data buffer while searching for at least one keyword is being performed;
upon detecting a match, updating the search result list; and
reporting the result of the searching to a host.

8. The method of searching, as recited in claim 7, wherein the parsing includes a list of keyword employed in the searching step.

9. The method of searching, as recited in claim 7, wherein the searching step includes searching for a part of the block.

10. The method of searching, as recited in claim 9, wherein if the searching yields no match, searching another part of the block and repeating searching parts of the block until the entire block is searched.

11. The method of searching, as recited in claim 1, further including receiving a write command from the host, the self-search storage device monitoring the data stream from the host to the storage medium.

12. The method of searching, as recited in claim 1, further including receiving a read command from the host, the self-search storage device monitoring the data stream from the storage medium to the host.
